(19) United States
(12) Patent Application Publication
(10) Pub. No.: US 2026/0170663 A1
(43) Pub. Date: Jun. 18, 2026

(54) SYSTEMS AND METHODS FOR MULTI-OBJECT TRACKING

(71) Applicant: Board of Regents. The University of Texas System, Austin, TX (US)

(72) Inventors: William BEKSI, Arlington, TX (US); Md Ahmed AL MUZADDID, Arlington, TX (US)

(21) Appl. No.: 19/422,806

(22) Filed: Dec. 17, 2025

Related U.S. Application Data
(60) Provisional application No. 63/735,005, filed on Dec. 17, 2024.

(51) Int. Cl. G06T 7/20; G06T 7/70; G06V 10/25; G06V 10/74; G06V 20/10

(52) U.S. Cl. CPC G06T 7/20; G06T 7/70; G06V 10/25; G06V 10/74; G06V 20/188; G06T 2207/10016; G06T 2207/30188; G06T 2207/30241

(57) ABSTRACT

A system for multi-object tracking can incorporate an optical input device to generate video or images, for example a plurality of frames (e.g. video) based on optical information or data input or obtained by the optical input device. The system can in some instances incorporate a detector component in operable communication with the optical input device, which can be configured to identify a plurality of objects in each frame of the plurality of frames. The system can in some instances incorporate a tracking component to generate a plurality of trackers, wherein each tracker corresponds to a unique object of the plurality of objects in each frame, and each tracker determines an object trajectory over the plurality of frames.

### CROSS-REFERENCE TO RELATED APPLICATIONS

This application claims priority to U.S. Provisional Patent Application No. 63/735,005 filed on Dec. 17, 2024, which is incorporated herein by reference in its entirety.

### FIELD

The technology described herein generally relates to systems and methods for object detection and tracking, more particularly to multi-object detection and tracking in dynamic environments.

### BACKGROUND

In agriculture, automating the accurate tracking of cultivated plants, such as fruits, vegetables, and fiber, is a complex problem. One particular scenario where automated detection and tracking run into many issues is in dynamic field environments. However, the information gathered through object tracking in the agricultural setting is critical for making day-to-day agricultural decisions, assisting breeding programs, and other growing and/or operational decisions.

Current techniques for object detection and tracking rely on manual procedures, such as counting objects over small areas over time, or alternatively rely on static models that do not take into account many parameters and variability within a dynamic setting.

Accordingly, the technology described herein provides improvements over conventional sensing and tracking techniques through a modular tracking system and/or framework that combines accurate object detection and improved object tracking that in some aspects further leverages relationships between locations and trajectories of neighboring tracks.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

At a high level, embodiments of the technology described herein are generally directed towards object detection and tracking systems and methods, that in some instances, can be employed in a dynamic environment while maintaining a high degree of accuracy. According to some implementations, systems and methods described herein provide superior object detection, counting, and tracking over conventional systems and methods.

According to some embodiments, a system for multi-object tracking is provided. The system for multi-object tracking can include one or more components or modules, and in some cases incorporate an optical input device to generate video or images, for example a plurality of frames (e.g. video) based on optical information or data input or obtained by the optical input device. The system can in some instances incorporate a detector component in operable communication with the optical input device, which can be configured to identify a plurality of objects in each frame of the plurality of frames. The system can in some instances incorporate a tracking a tracking component to generate a plurality of trackers, wherein each tracker corresponds to a unique object of the plurality of objects in each frame, and each tracker determines an object trajectory over the plurality of frames. In some instances, the system can output a number of objects or otherwise determine a number of objects from the video or one or more images or frames.

According to some embodiments, a method for multi-object tracking is provided or alternatively a method for object counting. In some aspects, a method can include generating a plurality of frames based on optical information obtained via an optical input device, the plurality of frames comprising at least a current frame and a previous frame. In some aspects, the method can include determining a set of detections for each frame of the plurality of frames, each detection corresponding to a bounding box associated with a unique object in each frame. In some aspects, the method can include associating each detection with a tracker based at least on the tracker's predicted bounding box in the current frame. In some aspects, the method can include tracking objects over a given time and in some cases based on a video. In some aspects, the method can determine or output a number of objects or otherwise determine a number of objects from the video or one or more images or frames.

Additional objects, advantages, and novel features of the technology are set forth in part in the detailed description which follows, and in part will become apparent to those skilled in the art upon examination of the following, or can be learned by practice of the invention.

### BRIEF DESCRIPTION OF THE DRAWINGS

Aspects of the technology presented herein are described in detail below with reference to the accompanying drawing figures, wherein:

FIG. 1 illustrates an example flow of an example multi-object detection and tracking system and/or method, in accordance with some aspects of the technology described herein;

FIG. 2 illustrates an example cotton filed that can be used in collecting data, in accordance with some aspects of the technology described herein;

FIG. 3a illustrates aspects of multi-object tracking, in accordance with some aspects of the technology described herein;

FIG. 3b illustrates aspects of multi-object tracking, in accordance with some aspects of the technology described herein;

FIG. 4 illustrates a schematic of an example pipeline of a multi-object detection and tracking system and/or method, in accordance with some aspects of the technology described herein;

FIG. 5a illustrates example aspects of relative distance between neighboring cotton bolls, in accordance with some aspects of the technology described herein;

FIG. 5b illustrates example aspects of relative distance between neighboring cotton bolls, in accordance with some aspects of the technology described herein;

FIG. 5c illustrates example aspects of relative distance between neighboring cotton bolls, in accordance with some aspects of the technology described herein;

FIG. 5d illustrates example aspects of relative distance between neighboring cotton bolls, in accordance with some aspects of the technology described herein;

FIG. 6a shows examples of annotated cotton boll field images, in accordance with some aspects of the technology described herein;

FIG. 6b shows examples of annotated cotton boll field images, in accordance with some aspects of the technology described herein;

FIG. 6c shows examples of annotated cotton boll field images, in accordance with some aspects of the technology described herein;

FIG. 6d shows examples of annotated cotton boll field images, in accordance with some aspects of the technology described herein;

FIG. 6e shows examples of annotated cotton boll field images, in accordance with some aspects of the technology described herein;

FIG. 6f shows examples of annotated cotton boll field images, in accordance with some aspects of the technology described herein;

FIG. 6g shows examples of annotated cotton boll field images, in accordance with some aspects of the technology described herein;

FIG. 6h shows examples of annotated cotton boll field images, in accordance with some aspects of the technology described herein;

FIG. 7 shows an example scenario and qualitative comparison between a multi-object detection and tracking system and conventional methods, in accordance with some aspects of the technology described herein;

FIG. 8 shows an example scenario and qualitative comparison between a multi-object detection and tracking system and conventional methods, in accordance with some aspects of the technology described herein; and

FIG. 9 shows example re-identification results of a multi-object detection and tracking system, in accordance with some aspects of the technology described herein.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps disclosed herein unless and except when the order of individual steps is explicitly described.

It should be recognized that the exemplary embodiments herein are merely illustrative of the principles of the invention. Numerous modifications and adaptations will be readily apparent to those of skill in the art without departing from the spirit and scope of the invention.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

At a high level, embodiments of the technology described herein are generally directed towards object detection and tracking systems and methods, that in some instances, can be employed in a dynamic environment while maintaining a high degree of accuracy. According to some implementations, systems and methods described herein provide superior object detection, counting, and tracking over conventional systems and methods. In some aspects, systems, devices, and methods described herein are directed towards an object tracker, or multi-object tracker, or a tracking framework that can be implemented and is operable in dynamic environments, under a variety of conditions. An object tracker, multi-object tracker, and/or tracking framework is also referred to herein as NTrack, in some instances.

As will be appreciated, and discussed herein, embodiments of the of the present technology in some aspects enable improved computing systems, for example automation systems (e.g. agricultural automation systems), computer vision or digital vision, further in conjunction with automation processes, and improved visual or digital tracking through the implementation of one or more portions of frameworks described herein. In some aspects, embodiments of the present technology improve computing systems, more particularly, computer vision technologies or digital imaging or image capture and tracking through such imaging. According to various aspects of the present technology, the tracking systems and/or methods disclosed herein (e.g. multi object tracker, multiple object tacking framework) can be implemented to detect objects and/or count objects, but further can implement components or modules that enable the inference of an occluded object's location based on the visibility of its neighbors, and allows or enables the tracker to maintain identity or detection even under the existence of heavy occlusions. As will be appreciated, the technology disclosed herein provides a marked improvement in the underlying technology of computer vision, visual tracking, and/or automation, and in once specific instance, among other aspects, overcomes the limitations of conventional appearance-based reidentification techniques, and further, aspects of the present technology advance vision-based (e.g. digital imaging, vision, computer vision, automation) precision identification, counting, and in some specific example aspects plant phenotyping.

According to some aspects, a multiple-object tracker (or tracking framework or multiple object tracking system) is implemented for object tracking or multiple object tracking in a given environment or under given environmental conditions. In some instances, the environmental conditions may be static. In some other instances, the environmental conditions are dynamic, i.e. that is they can change over a time period.

In some aspects, a tracker or tracking system (e.g. multiple object tracker, multiple object tracking system, multiple object tracking framework) can include, among other components, a data collection device (e.g. optical input device) which can capture one or more images, or capture video or a video stream. In some aspects, a data collection device or optical input device is implemented as an image or video capture component or module. In some aspects, subsequently, one or more frames can be extracted from the images or video collected, e.g. by a frame extraction component or module. In some aspects, the one or more frames, or plurality of frames extracted and/or collected can be passed to a detector component or module, which can detect one or more objects in each frame, for example, one or more of a specified (or pre-determined) object can be detected. In some aspects a plurality of detections can be made for each frame (e.g. each frame of a plurality of frames input to the detector component). The object detections (i.e. plurality of detections for each frame) can then be input to a tracker component or module. In some additional, or other aspects, video or images captured can also be input to the tracker component or module. In some instances, the video can be input in real-time or near real-time. In some instances, the detections and the video can be input to the tracker component or module simultaneously or individually, in any order. In some aspects, a number of objects can be output from the tracker. In some instances, a number of objects can be output from the tracker over a defined or determined or predetermined period of time.

The present technology may be embodied as, among other things, a system, method, or computer-product, amongst other implementations. Accordingly, embodiments may take the form of a hardware embodiment, a software embodiment, or an embodiment combining software and hardware. In one embodiment, the present invention takes the form of a computer program product that includes computer useable instructions embodied on one or more computer readable media, or storage media, and executed by one or more processors. Computer storage media or machine readable media can include media implemented in any method or technology for storing and/or transmitting information or data. Examples of such information include computer-useable instructions, data elements, data structures, programs and program modules, and other data representations. In some aspects, systems and methods described herein can be implemented in or on one or more devices or systems, for example local systems and devices or as a distributed system.

In one example aspect, systems and methods described herein can be implemented to provide highly accurate estimates of a total number of objects across an agricultural setting such as a farm, for instance cotton bolls or other non-rigid soft body objects. A tracking framework can automate the counting processes of cultivated plants using a dynamic motion model that can identify, and subsequently re-identify those objects if and/or when they become occluded in a field of vision or for example under varying lighting conditions. As will be appreciated this information can be beneficial, for instance to agronomists and breeders as it can enable an accelerated selection of genotypes and identify plant cultivars that exhibit certain tolerances to adverse environmental conditions, for example drought, poor soil quality, etc. via yield predictions.

In some aspects, an object tracking framework can be based, in part, on generated tracks corresponding to a plurality of objects in a given environment and the linear relationship the locations of neighboring tracks. The object tracking framework can determine, estimate, and/or compute dense optical flow of objects between previous and current frames and can further utilize particle filtering to guide or direct each tracker. Correspondences between detections and generated tracks can be found or determined through data association via direct observations and indirect cues, which can be subsequently combined to obtain an updated observation. In some further embodiments, the object tracking framework is modular, and can be independent of the underlying object detection method which can enable the interchangeability of or the ability to swap object detectors in the system.

According to some aspects, multi-object tracking is based on digital imaging of a field of view to detect or identify relevant objects or objects of interest and subsequently track those objects over a period of time, during which additional objects may be detected and tracked. Accordingly, as will be appreciated, optical inputs or optical feeds (e.g. video capture) in operable communication with multi-object tracking systems can provide a plurality of frames, for example as data inputs, on which the multi-object tracking system can act. In some aspects, multi-object tracking systems can generate tracks for objects identified in any of the plurality of frames of an image capture and determine and/or further estimate trajectories of the objects and/or the tracks over the plurality of frames, for examples a time series of frames.

In some embodiments, a system for multi-object tracking is provided. In some embodiments, the system can include an optical input device to generate a plurality of frames based on optical information obtained via the optical input device. It will be appreciated that the plurality of frames may be provided in real-time, for example as a digital video feed or sent to the system as part of a batch process. The system can also include a detector component in operable communication with the optical input device to identify a plurality of objects in each frame of the plurality of frames and further a tracking component to generate and/or initialize a plurality of trackers, wherein each tracker corresponds to a unique object of the plurality of objects in each frame, and each tracker determines an object trajectory, or in some instances a tracker trajectory, over the plurality of frames. Based on the plurality of frames, the detector component can determine a bounding box for each object of the plurality of objects identified in each frame. In some instances, the detector component may not identify any object in a given frame.

In some aspects, the multi-object system can include an optical flow module to determine dense optical flow over the plurality of frames based on a current frame and a previous frame. Generally, dense optical flow is determined from a first frame to a second frame, and so on, or determined based on a current frame with respect to a previous frame. Based on a dense optical flow calculation or algorithm, optical flow vectors can be generated or output for each pixel in a frame. Based on dense optical flow, the multi-object system can utilize a predict module to predict the location of a tracker in each frame based on a particle filter, more particularly in each new frame or current frame, with respect to a previous frame or a plurality of previous frames.

In some aspects the multi-object system can include an association module to determine a set of correspondences between one or more objects identified in each frame and one or more trackers, in some instances based on a set of matching criteria. The association module can determine correspondences between a tracker's predicted state (i.e. in a current frame) and a set of detection bounding boxes, each of the detection bounding boxes corresponding to an object in a frame or an object being tracked. Further, the association module can determine one or more unmatched tracks or trackers, that is, a track that cannot be matched to a detection bounding box in a given frame. These unmatched, or in some instances dormant, tracks can subsequently be analyzed by a relative location analyzer component and updated; in some instances the relative location analyzer can additionally estimate the unmatched (or dormant) tracks location based on the locations of one or more of the nearest neighbors tracks or locations. Further, unmatched detections found by the relative location analyzer can be passed to an initialize module as a candidate for a new track, which can be generated or initialized based on a threshold determination.

Accordingly, the multi-object system can further include a relative location analyzer (RLA) module to estimate a present location of a tracker in a frame based on the tracker's past trajectory and one or more neighboring tracker's past trajectory, i.e. based on the tracks over a plurality of previous frames with respect to a current frame. The multi-object system can additionally include a refiner module that can suppress a tracker if the tracker's location is determined to be outside a frame and/or the tracker cannot be matched against a detection in a set of recent frames.

In some aspects, the association module can generate an association set. An association set can include one or more active tracks corresponding to matches between identified objects and associated trackers in the plurality of trackers, one or more dormant tracks corresponding to non-matches between identified objects and associated trackers in the plurality of trackers (i.e. the track is unmatched), and one or more unmatched detections corresponding to identified objects and no associated trackers in the plurality of trackers (i.e. the object or detection is unmatched). Based on outputs of the association module, the location states associated with the active tracks and/or the dormant tracks can be updated for a current frame and further one or more new tracks can be initialized based on the unmatched detections and a detection confidence threshold.

According to some further embodiments, a method for multi-object tracking is provided. In some aspects, a method can include generating a plurality of frames based on optical information obtained via an optical input device, the plurality of frames comprising at least a current frame and a previous frame, determining a set of detections for each frame of the plurality of frames, each detection corresponding to a bounding box associated with a unique object in each frame, and associating each detection with a tracker based at least on the tracker's predicted bounding box in the current frame. In some instances, the associating can additionally include a tracker or track initialization for newly identified objects in a frame, the objects defined in a given frame by a bounding box.

Over a plurality of frames, the method can further include determining a tracker trajectory for each tracker based on the detected bounding boxes and the associated tracker over the plurality of frames. In some instances, a tracker trajectory can be referred to as a track where the track is based on a detected bounding box (i.e. detection) and its associated tracker over a plurality of frames. In some aspects, the method can include determining a tracker is active if the tracker can be associated with a detection in a frame and/or determining a tracker is inactive if the tracker cannot be associated with a detection in a frame.

In one aspect, methods can include determining a dense optical flow for a current frame with respect to a previous frame. Based on flow vectors output by the dense optical flow calculation or algorithm, a location (or current location) in a current frame can be predicted for each tracker, or in some instances for each track. In some instances, the predicting can be based on each trackers trajectory and/or past trajectory and one or more neighboring trackers trajectories and/or past trajectories.

In some implementations, a method described herein further comprises finding correspondences, or determining and/or generating an association set, between a tracker's predicted state and a set of detection bounding boxes provided by a detector component. An association set can include one or more active tracks corresponding to matches between identified objects and associated trackers in the plurality of trackers, one or more dormant tracks corresponding to non-matches between identified objects and associated trackers in the plurality of trackers (i.e. the track is unmatched), and one or more unmatched detections corresponding to identified objects and no associated trackers in the plurality of trackers (i.e. the object or detection is unmatched). Based on outputs of the association module, the location states associated with the active tracks and/or the dormant tracks can be updated for a current frame and further one or more new tracks can be initialized based on the unmatched detections and a detection confidence threshold. In some further instances, the state of an active tracker or track is updated for the current frame and/or the state of an inactive tracker or track is updated for the current frame.

### Example(s)

In agriculture, automating the accurate tracking of fruits, vegetables, and fiber is a very tough problem. The issue becomes extremely challenging in dynamic field environments. Yet, this information is critical for making day-to-day agricultural decisions, assisting breeding programs, and much more.

In light of the problems in the field of computer vision, particularly in dynamic environments, and to address the above-noted challenges, a multiple-object tracker or tracking framework (referred to herein as NTrack) can be implemented, which can be viewed as a novel multiple object tracking framework based on the linear relationship between the locations of neighboring tracks. NTrack computes dense optical flow and utilizes particle filtering to guide each tracker. Correspondences between detections and tracks are found through data association via direct observations and indirect cues, which are then combined to obtain an updated observation. Our modular multiple object tracking system is independent of the underlying detection method, thus allowing for the interchangeable use of any off-the-shelf object detector. Efficacy of the approach is shown on the task of tracking and counting infield cotton bolls. Experimental results show that systems and methods according to aspects of the present technology exceed contemporary tracking and cotton boll-based counting methods by a large margin. Accordingly, this can further be expanded to apply to any object detection and tracking, or further to object detection and tracking under unfavorable conditions or when there is occlusion of the objects involved.

This work is motivated by the need to provide highly-accurate estimates of the total number of cotton bolls across an entire farm. We provide a multiple object tracking framework for automating the counting process using a dynamic motion model that can re-identify severely occluded objects. This information is immensely beneficial to agronomists and breeders. For example, it can allow them to accelerate the selection of genotypes and identify cotton cultivars that exhibit tolerance to adverse environmental conditions (e.g., drought, poor soil quality, etc.) via yield prediction. Since the performance of our tracker is tied to the accuracy of the object detector, the ability to swap detectors is important for enhancing the usability of the system. Our dataset structure was modeled after similar multiple object tracking datasets for the purpose of increasing adoption among practitioners. To implement our system, it is assumed that the image/video capture device is of high resolution and data is acquired under ideal lighting conditions. In some aspects, the framework can be run on a commercial-off-the-shelf platform (e.g., ground-based robots, unmanned aerial vehicles, etc.), with sufficient computing and memory resources, using a vision-based sensor.

Cotton (Gossypium hirsutum L.) is a vital source of natural fiber. It accounts for nearly 25% of total world textile fiber use. Not only is cotton one of the most important textile fibers in the world, but it has also become a substantial source of food and feed for humans and livestock by providing cottonseed oil and hulls. Improving the production of cotton is essential to fulfilling the fiber, food, and feed requirements of the Earth's increasing population. In addition, cotton is a high-valued crop that requires a significant number of inputs such as preparing seed beds, planting, reducing competition from insects and weeds, applying harvest aids, and harvesting. Therefore, among stakeholders, the high return value and cost of cotton production provides incentives for embracing technologies to improve profitability by reducing expenses and boosting yields.

Infield cotton boll counting is key to predicting fiber yield as well as providing a better understanding of the physiological and genetic mechanisms of the crop's growth and development. Repeated counting can contribute to the calculation of the growth rate in the flowering and boll maturity stages, and allow for selecting genotypes that more effectively utilize their energy to form cotton products. The standard approach to obtain yield information is by manual field sampling, which is tedious, labor intensive, and expensive. Constrained by these limitations, sampling is done over a few separate crops and the measurements are extrapolated over an entire farm. However, inherent human bias and sparsity in the measurements can result in inaccurate yield estimation. Improving yield is a primary objective in cotton management projects. Physiological factors and environmental variables all have an effect on flower and boll retention. Understanding these processes is crucial not only to enhancing cotton yield, but also to advancing the study of plant phenotyping, i.e., the process of measuring and analyzing observable plant characteristics.

The last few decades have seen remarkable advances in vision-based object tracking. This research has mainly been applied to tracking pedestrians and vehicles, with benefits to many other important applications such as surveillance, traffic safety, autonomous driving, and more. Nevertheless, vision-based tracking has not evolved proportionally for the agricultural domain. There is a dire need for tracking algorithms and datasets to support operations in agriculture. For instance, plant detection and tracking may be utilized to optimize the usage of water, fertilizer, or other chemicals through variable-rate applications. Accurately counting the number of leaves, flowers, fruits, etc., is vital for yield prediction and plant phenotyping. Nondestructive, high-throughput data acquisition platforms (e.g., unmanned aerial vehicles, ground-based robots, etc.) are enabling experts to analyze more of this data for optimization.

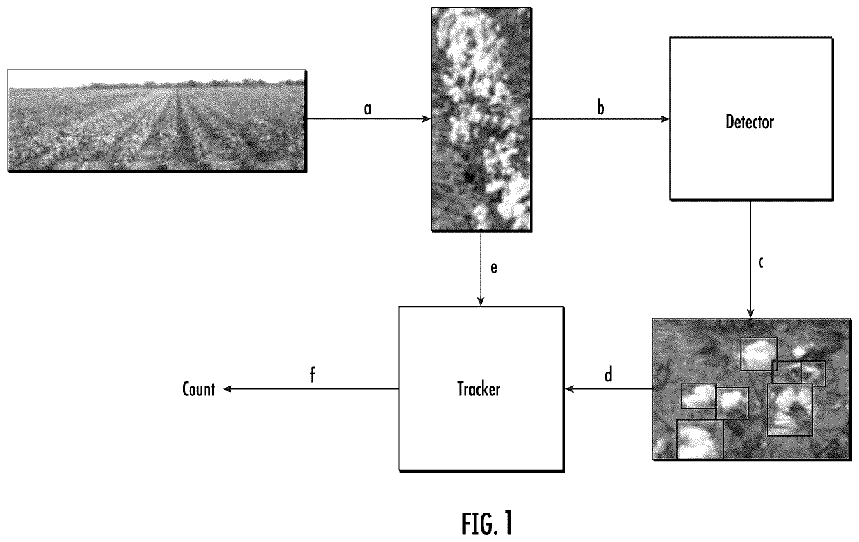

Detecting cotton bolls is a hard problem and tracking cannot be done if the object detector fails. Bolls are often clustered together and they may be split into two or more disjoint regions by branches, foliage, or other occlusions. In contrast to fruits with rigid shapes (e.g., apples, oranges, etc.), cotton bolls have complex structures and varied sizes. Hence, the ability to detect and provide a highly-accurate count of the total number of cotton bolls in a given field is an open problem that is addressed with aspects of the present technology, for example through the implementation of framework, for example shown in FIG. 1.

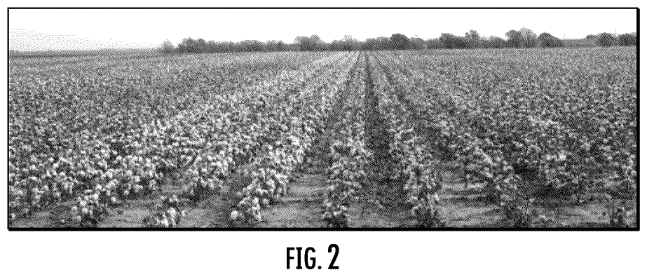

The lack of high-quality datasets is a significant roadblock for meaningful progress in precision plant phenotyping. Annotated video datasets for cotton crops are nonexistent. With the aim of establishing a robust system for tracking and counting cotton bolls, we created, an infield cotton boll video dataset. Each tracking sequence was collected from unique rows of an outdoor cotton crop research plot located in the High Plains region of Texas, FIG. 2. The research plot is comprised of multiple varieties of cotton. Specifically, each row contains the same cultivar of cotton while different rows have unrelated cultivars. This results in a diverse variety of cotton boll shapes and sizes. Additionally, we captured video sequences from rows treated with contrasting levels of irrigation, which has a direct impact on the size and the shape of bolls.

Accordingly, aspects of the present technology are directed towards object detection and tracking systems which in some instances can infer an occluded objects location based on visibility of its neighbors, and enable the tracker to maintain identity even under the existence of heavy occlusions. Object trackers described herein can also, in some aspects, outperform conventional systems that have limitations in appearance-based reidentification techniques.

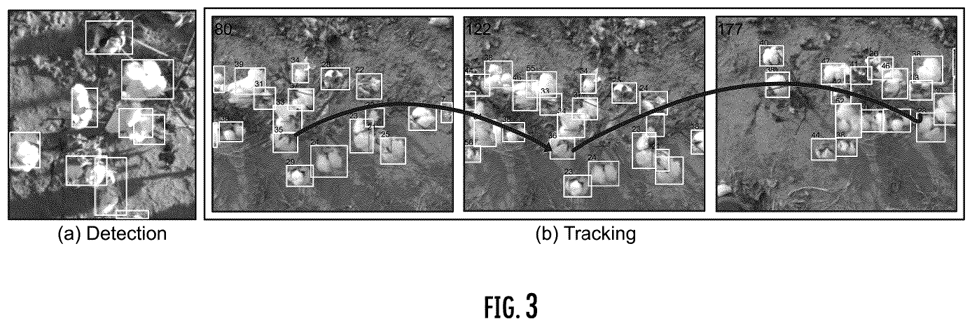

Detecting and tracking objects is one of the most fundamental tasks in computer vision. Object detection is the process of identifying a target object in an image or a single video frame. Specifically, it is the task of detecting instances of objects that belong to a certain class. Object tracking seeks to predict the positions, and other pertinent information, of moving objects in a video. Single-object tracking involves the following steps: (i) detect the location of the object, (ii) assign a unique identification to the object, and (iii) track the object as it moves through the video sequence while storing the relevant information. In multiple object tracking (MOT), given an input video the task is partitioned into locating multiple objects, maintaining their identities, and yielding their individual trajectories. The overall process is shown in FIG. 3. As can be seen in FIG. 3, multiple object tracking can in some aspects comprise multiple steps, which may be divided across components or modules, as seen in FIG. 3a and FIG. 3b, multiple object tracking can include detecting the location of one or more objects in a frame and placing bounding boxes around the objects (i.e. detection or detection phase). In some aspects, multiple object tracking can include associating a unique identifier or identification to each object (i.e. each detected object) which can subsequently be used to track one or more trajectories of the objects as they pass through the video sequence (e.g. across a set of frames of a video).

MOT approaches can be categorized into online and offline (batch) tracking. While offline tracking optimizes output based on past and future observations, online tracking only has access to information up until the current frame. Offline methods formalize tracking as an association problem and are solved by using global optimization techniques. For example, early work by Zhang et al. used a probabilistic model to associate detections with tracks by solving an augmented mincost flow problem. A hierarchical association framework that allows for the integration of affinity measures or optimization methods was put forth by Huang et al. Yang et al. attempted to find the best global associations and transformed the task of finding these associations into an energy minimization problem.

With limited information, online methods tend to be implemented in a greedy fashion. Currently, the dominant approach for online tracking follows a tracking-by-detection paradigm. When performing tracking-by-detection, an object detector first localizes all objects of interest via a set of bounding boxes. Then, the tracking system associates bounding boxes with preexisting tracks based on motion, appearance, spatial, or other affinities. As a result, object detection accuracy plays a decisive role in the final tracking performance. However, many methods only consider detection boxes whose scores are higher than a set threshold. Objects with low detection scores (e.g., due to occlusions) are discarded, which results in sub-optimal results. Trackers such as ByteTrack try to solve this problem by considering nearly every detection in their association method.

Various motion models have been used to estimate spatial affinity including the bounding box intersection over union and Euclidean distance metrics. For instance, to estimate a pedestrian's velocity, Leal-Taixe et al. introduced an interaction feature encoded from image features based on the pedestrian's environment. Bewley et al. used a Kalman filter-based motion model to predict track positions while detections are associated via the Hungarian algorithm.

To overcome the linearity and Gaussian restriction of the Kalman filter, Okuma et al. utilized a particle filter for tracking. Li et al. used a cascade particle filter, which consists of multiple stages of importance sampling to track objects in low frame rate videos. Optical flow was exploited by Choi to encode the relative motion pattern for estimating the likelihood of matching detections. Yoon et al. considered time-varying multiple relative motion models to represent motion context and facilitate data association. Although these approaches exploit relative motion, their constant velocity motion model is not applicable for many scenarios including ours.

Mauri et al. discussed the use of depth, predicted from monocular images using self-supervised depth estimation to estimate vehicular motion. Unfortunately, coarse depth estimation based on such techniques cannot be used in our situation. These models are not able to distinguish between two cotton bolls at slightly different depths. In our approach, we use an optical flow-based dynamic motion model along with a relative location estimator to update object locations.

Similar to motion models, appearance models are extensively used in MOT. An appearance model extracts reidentification features from image regions corresponding to each bounding box. Appearance-based affinity metrics have proven to be very informative in the presence of long-occlusion intervals. Examples include POI, Deep-SORT, and Tracktor, which extract appearance features using deep convolutional neural networks (CNNs). Recent transformer-based approaches (e.g., TrackFormer) also use implicit appearance cues to reidentify objects. More traditional methods have been used too. For instance, region covariance matrices, color histograms, and gradient-based representations, may be leveraged to find appearance-based similarity. In contrast to these works, we propose a relative location-based re-identification technique that can handle significant changes in appearance due to long-spanning occlusions.

Precisely detecting and tracking objects is imperative for automated fruit/vegetable/fiber counting. In work by Hung et al., apple trees were sampled every 0.5 meters to estimate yield by counting the apples in each non-overlapping image. Chen et al. implemented a two-stage method to count apples and oranges from images. An incremental structure from motion technique was proposed by Roy and Isler to register and localize apples in 3D, which is later used for extracting the count. Hani et al. first identified apple clusters in images based on color, and then used a CNN to classify the clusters where each class represents the number of apples in the cluster. Afonso et al. provided a detectionbased approach to enumerate tomatoes in images captured from a greenhouse environment. A DeepSORT inspired tracking method to count fruit in a controlled setting was used by Kirk et al. All of the aforementioned techniques tally fruits composed of rigid shapes, which are simpler to separate into clusters thus making the counting task easier. On the other hand, counting irregular-shaped cotton bolls under dynamic field conditions is far more challenging.

To acquire information for yield prediction, recent research has developed algorithms to segment and count cotton bolls. Sun et al. introduced a counting method based on the geometric features of cotton bolls. This was done by applying color and spatial features to segment bolls from the background, followed by geometric feature-based algorithms to estimate the boll count. Tedesco-Oliveira et al. used different deep learning-based object detection models on a cotton crop dataset consisting of 948 images for training, 236 images for validation, and 205 images for testing. By comparison, our dataset is significantly larger and we employ a model that is capable of detecting objects of various sizes. Sun et al. take a 3D approach to counting cotton bolls by using point clouds reconstructed from multi-view images via structure from motion under field conditions.

All of the preceding methods investigate the counting of cotton bolls from images. Image-based counting requires automated or manual sampling. For example, Tedesco-Oliveira et al. selected 25 dissimilar images so that there were no overlapping images in each video sequence. Such sampling-based methods demand additional pre-processing and post-processing steps. Conversely, our approach not only eliminates this overhead without sacrificing accuracy, but it also achieves better accuracy than previous works. Moreover, we argue that counting from videos has the potential to locate additional cotton bolls since the counting sequence enables an automated system to find bolls that may otherwise be occluded in a single image. To the best of our knowledge, our work is the first to engage in the cotton boll counting task directly from infield video sequences.

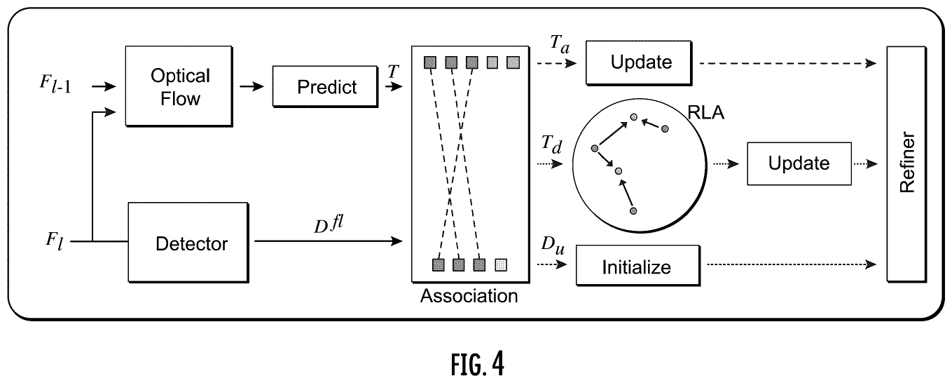

The architectural overview of NTrack is depicted in FIG. 4. Similar to other tracking-by-detection systems, the performance of NTrack highly depends upon the detection accuracy. We assume that the detection bounding boxes in every frame are estimated prior to tracking. The tracking procedure is independent of the underlying detection algorithm, which allows NTrack's Detector module to use any object detection method to identify cotton bolls.

Multiple tracks, each linked to a unique cotton boll and steered/guided by a particle filter, are responsible for estimating the location of an associated boll. The job of the Association module is to find the correspondences between detections and tracks based on a matching criteria. Given a track's past trajectory along with its neighbors' trajectories, the Relative Location Analyzer (RLA) module can estimate the current location of the track. A track is suppressed by the Refiner module if the track's location goes out of the frame border or it cannot be matched against a detection in recent frames.

We denote a set of detections by D={rᵢ}, where ri is the detection response represented as the tuple (xᵢ, yᵢ, sᵢ, wᵢ, fᵢ). Within the tuple, (xi, yi) is the center, sᵢ is the size, and wᵢ is the width of the detected bounding box. The frame/time at which an object is detected is defined by fᵢ. Note that we use fᵢ to denote both the frame and time interchangeably. D^{fl}∪D is the set of bounding boxes detected in frame f₁. We define a track τₖ∈T over multiples frames by a set of bounding boxes associated with a particular object, where T represents the set of all tracks in the system. Ideally, each object is associated with a single track. In reality, maintaining a perfect one-to-one mapping between an object and a track is impossible due to occlusions, misdetections, and ambiguous associations. Therefore, a track is active in a given frame if the system can successfully associate the track's predicted bounding box with a detected bounding box, otherwise it is dormant.

For each new frame F₁, dense optical flow is computed by the Optical Flow module with respect to the previous frame F₁₋₁ based on the Gunnar-Farneback algorithm. Optical flow vectors are outputted for each pixel of the frame. Next, informed by these flow vectors, all tracks predict their new location in frame F₁ via the Predict module. Each track employs a particle filter for the prediction and update step. The particle filters track the bounding box locations (centers). Nonetheless, since the camera motion and movement of the objects are irregular, neither a constant velocity nor constant acceleration model-based state estimation performs as expected. Hence, we apply a dynamic flow velocity model for the bounding box location estimation. Unlike location, the scale and width of the bounding box changes gradually and is therefore tracked by a Kalman filter using a constant velocity model.

With the detection bounding boxes provided by the tracks, the Association module attempts to make a unique correspondence between two sets of bounding boxes. It produces the following outputs: (i) a set of active tracks Ta successfully matched against detections Dₘ, (ii) a set of dormant tracks T_{d}=T\Tₐ, and (iii) a set of unmatched detections Dᵤ=D^{fl}\Dₘ. The particle filters associated with the active tracks Tₐ update their state using the information from matched detections Dₘ through the Association module's Update module. The dormant track T_{d}'s states are analyzed by the RLA and updated via its Update module. If any of the remaining unmatched detections Dᵤ exceeded a detection confidence threshold, then they are initialized as new tracks (Initialize module). Lastly, the Refiner module removes any track that was dormant for the last 100 frames.

With reference to FIG. 4, aspects of a multi-object tracker framework, system, or dataflow (NTrack pipeline) is illustrated. The Association module finds correspondences between the predicted state of T tracks (e.g. top left three squares). D^{fl} is the set of detection bounding boxes (e.g. bottom left three squares) detected in frame F₁. The dormant (unmatched) tracks T_{d} (e.g. top right two squares) are analyzed by the Relative Location Analyzer (RLA) module and updated accordingly. In the RLA module, the dormant tracks' locations (circles with incoming arrows) are estimated based on the location of their nearest neighbors (circles with outgoing arrows). Unmatched detections Dᵤ. (e.g. bottom rightmost square) are passed through the Initialize module as candidates for a new track.

Object location prediction. Instead of using known motion models to predict the next state (xᵢ, yᵢ, sᵢ, wᵢ) of the object, we use optical flow-based motion estimation. Due to outdoor environmental conditions (e.g., wind), the branches of a cotton plant can sway back and forth. Moreover, the camera movement over the terrain is erratic, which causes irregular motion dynamics. Even under these adverse conditions, we are still able to find reliable locations of the tracked objects in image coordinates through optical flow. In the prediction step, the particles of the particle filter are moved according to the estimated flow velocities. Since we have multiple targets per frame, we opt for a robust to noise dense optical flow algorithm instead of sparse flow, which would require estimating flow separately for each object.

Object location update. During the update phase, a track could be in an active or dormant state based on the association outputs. Thus, we use one of two different routines to update a track. If the track is active in frame fₗ, then we update the weight of the particles based on direct observation (i.e., the detected object bounding box from the detector). Otherwise, we use the relative locations with respect to the neighboring tracks as indirect observations to update the dormant track. More specifically, the relative locations are used to calculate the bounding box center, which is then used as a proxy for the direct observation in order to update the particle filter.

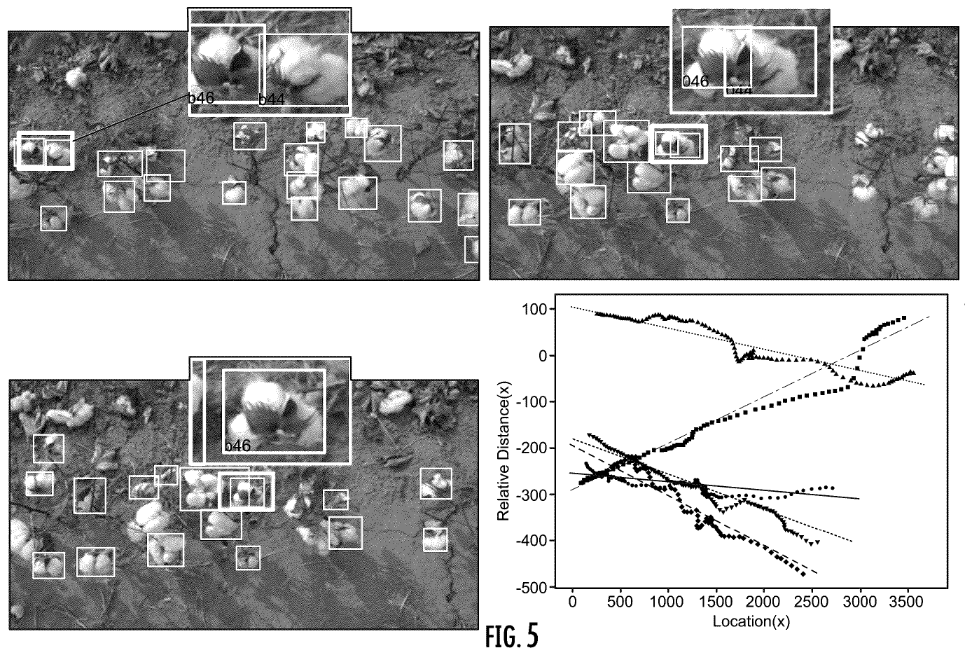

Relative object location. Cotton plants in the field may move unpredictably, which makes the tracking task much more difficult. However, the locations of the cotton bolls are not totally independent of each other. In fact, they are highly correlated with neighboring bolls, FIG. 5. More formally, we denote the location (x, y) of a track τᵢ in the image coordinate at time fₗ as

$${ρ}_{{τ}_{i}}^{{f}_{l}} ∈ {ℝ}^{2} .$$

The locations along the image width (x) and height (y) are independent, and the estimated location based on the neighbor track τⱼ is defined as

$${ρ}_{{τ}_{i} , {τ}_{j}}^{{f}_{l}} ∈ {ℝ}^{2} .$$

Similarly, we define

$${d}_{{τ}_{i} , {τ}_{j}}^{{f}_{l}} ∈ {ℝ}^{2}$$

as the relative distance of track τᵢ, with respect to neighbor τⱼ, recorded at time fₗ. For simplicity, in the following derivation we assume

$${ρ}_{{τ}_{i}}^{{f}_{l}} , {ρ}_{{τ}_{i} , {τ}_{j}}^{{f}_{l}} ,$$

etc., are scalars and that they represent only the x component of the location. Based on the observed correlation (FIG. 5), we assume that the relative distance between two neighboring tracks changes linearly with the track's location. Concretely, let

$${d}_{{τ}_{i} , {τ}_{j}}^{{f}_{l}} = {c}_{1} \cdot {ρ}_{{τ}_{j}}^{{f}_{l}} + {c}_{0}$$

where c₁ and c₀ are constants. We derive the linear relationship between the locations of two neighboring tracks as

$$\begin{matrix}{d}_{{τ}_{i} , {τ}_{j}}^{{f}_{l}} & = {c}_{1} \cdot {ρ}_{{τ}_{j}}^{{f}_{l}} + {c}_{0} ,\end{matrix} \qquad ( 1 )$$

$${d}_{{τ}_{i} , {τ}_{j}}^{{f}_{l}} + {ρ}_{{τ}_{j}}^{{f}_{l}} \qquad = {c}_{1} \cdot {ρ}_{{τ}_{j}}^{{f}_{l}} + {c}_{0} + {ρ}_{{τ}_{j}}^{{f}_{l}} ,$$

$${ρ}_{{τ}_{i} , {τ}_{j}}^{{f}_{l}} \qquad = ( {c}_{1} + 1 ) \cdot {ρ}_{{τ}_{j}}^{{f}_{l}} + {c}_{0} ,$$

which suggests that the location of neighboring tracks can be a good estimator of a dormant track's location.

Based on this insight, we calculate track τᵢ's location at time fₗ based on a particular neighbor τⱼ as follows. Let

$${ρ}_{{τ}_{j}}^{{f}_{l}} and {ρ}_{{τ}_{i} , {τ}_{j}}^{{f}_{l}}$$

be continuous random variables. The linear relationship between a neighboring track's location implies that we can assume the mean

$$E [ {ρ}_{{τ}_{i} , {τ}_{j}}^{{f}_{l}} ]$$

is linear in

$${ρ}_{{τ}_{j}}^{{f}_{l}} .$$

At the same time, assuming the variance

$$var [ {ρ}_{{τ}_{i} , {τ}_{j}}^{{f}_{l}} ]$$

is constant of fₗ, we can model

$${ρ}_{{τ}_{i} , {τ}_{j}}^{{f}_{l}}$$

as a Gaussian random variable

$${ρ}_{{τ}_{i} , {τ}_{j}}^{{f}_{1}} ∼ 𝒩 ( {μ}_{{τ}_{i} , {τ}_{j}}^{{f}_{1}} , {σ}_{{τ}_{i} , {τ}_{j}}^{2} ) , \qquad ( 2 )$$

$$where$$

$$( \begin{matrix}ρ \text{?} \\ ρ \text{?} \\ ⋮ \\ ρ \text{?}\end{matrix} ) = ( \begin{matrix}1 & {ρ}_{{τ}_{j}}^{{f}_{1}} \\ 1 & {ρ}_{{τ}_{j}}^{{f}_{2}} \\ ⋮ & ⋮ \\ 1 & {ρ}_{{τ}_{j}}^{f} \text{?}\end{matrix} ) ( {{c}_{0} \atop {c}_{1}} ) + ( \begin{matrix}{e}_{1} \\ {e}_{2} \\ ⋮ \\ {e}_{m}\end{matrix} ) \text{?} \qquad ( 3 )$$

$${μ}_{{τ}_{i} , {τ}_{j}}^{{f}_{i}} = E [ {ε}_{{τ}_{i} , {τ}_{j}}^{{f}_{i}} ] = [ 1 {ρ}_{{τ}_{j}}^{{f}_{i}} ] \cdot {[ {c}_{0} {c}_{1} ]}^{T} \text{?} \qquad ( 4 )$$

$${σ}_{{τ}_{i} , {τ}_{j}}^{2} = var [ {ρ}_{{τ}_{i} , {τ}_{j}}^{{f}_{i}} ] = \frac{{\sum }_{i} {e}_{i}^{2}}{m} . \qquad ( 5 )$$

$$\text{?} \text{indicates text missing or illegible when filed}$$

We assume that there are m frames prior to frame fₗ in which tracks τᵢ and τⱼ were active simultaneously and the relative distances between them were recorded. c₀ and c₁ are the least-squares solutions to (3). Finally, the estimated locations

$${ρ}_{{τ}_{i} , {τ}_{j}}^{{f}_{l}} \vert {τ}_{j} ∈ kn ( {τ}_{i} )$$

based on k neighbors are combined as follows (for simplicity we drop the superscript fₗ):

$${p}_{{τ}_{i}} ∼ {\prod }_{{τ}_{j}} \text{?} 𝒩 ( {μ}_{{τ}_{i} , {τ}_{j} ,} {σ}_{{τ}_{i} {τ}_{j}}^{2} ) , \qquad ( 6 )$$

$$∼ β 𝒩 ( {μ}_{{τ}_{i} ,} {σ}_{{τ}_{i}}^{2} ) , \qquad ( 7 )$$

$$\text{?} \text{indicates text missing or illegible when filed}$$

where β is a scaling factor and

$${σ}_{{τ}_{i}} = {( {\sum }_{{τ}_{i} ∈ k} \text{?} {σ}_{{τ}_{i} , {τ}_{j}}^{− 2} )}^{− 1 / 2} , \qquad ( 8 )$$

$${μ}_{{τ}_{i}} = {σ}_{{τ}_{i}}^{2} {\sum }_{{τ}_{j} ∈ k} \text{?} {σ}_{{τ}_{i} , {τ}_{j}}^{− 2} {μ}_{{τ}_{i} , {τ}_{j}} . \qquad ( 9 )$$

$$\text{?} \text{indicates text missing or illegible when filed}$$

In (6) kn(τᵢ) is the set of τᵢ's neighbors with cardinality k, which is inspired by the Kalman filter's approach to combine the prior with an observation for an improved estimate. The simplification from (6) to (7) is due to a probability density function.

The neighbors kn(·) are selected based on the k-nearest neighbors algorithm. We measure the distances between the bounding box centers using their Euclidean norm. For a particular track τᵢ, we can end up with more than k neighbor locations in total, even if we record just k neighboring locations in each frame. In addition, we want to prioritize a neighbor that was simultaneously active with τᵢ in more frames in the recent past. Therefore, to choose k neighbors among all the recorded neighbors we rank each neighbor,

$${R}_{{τ}_{i}}^{{f}_{l}} ( {τ}_{j} ) = {\sum }_{{f}_{m} ∈ {A}_{{τ}_{i} , {τ}_{j}}^{{f}_{l}}} {f}_{m} , \qquad ( 10 )$$

where

$${A}_{{τ}_{i} , {τ}_{j}}^{{f}_{l}}$$

is the set of timestamps prior to fₗ in which tracks τᵢ and τⱼ were active simultaneously. For example, suppose tracks τᵢ and τₙ_{₁} are simultaneously active at time 2, 3, and 5. Ther

$${A}_{{τ}_{i} , {τ}_{n + 1}}^{{f}_{l}} = \{ 2 , 3 , 5 \}$$

and similarly

$${A}_{{τ}_{i} , {τ}_{n \_ + 2}}^{{f}_{l}} = \{ 5 , 6 \} .$$

In this case, we prioritize the neighbor n₂ according to the rank, which is higher than n₁ since

$${R}_{{τ}_{i}}^{{f}_{l}} ( {τ}_{{n}_{2}} ) = 5 + 6 > {R}_{{τ}_{i}}^{{f}_{l}} ( {τ}_{{n}_{1}} ) = 2 + 3 + 5 .$$

With reference to FIGS. 5a, 5b, 5c, and 5d, the relative distance between neighboring cotton bolls changes gradually due to the shift in perspective. At frame 1142, the distance between b46 and b44 is large (e.g. top left frame, FIG. 5a). At frame 1203, the distance between the bolls reduces (e.g. top right frame, FIG. 5b). At frame 1212, both bolls overlap, i.e. the distance is zero (e.g. bottom left, FIG. 5c). The plot shows the relative distances between pairs of cotton bolls versus their locations (e.g. bottom right, FIG. 5d). The distance and location are measured in image coordinates along x (width) direction. Each dotted line shows the distance between a pair of cotton bolls. The straight lines are linear fits to their respective tracked pair.

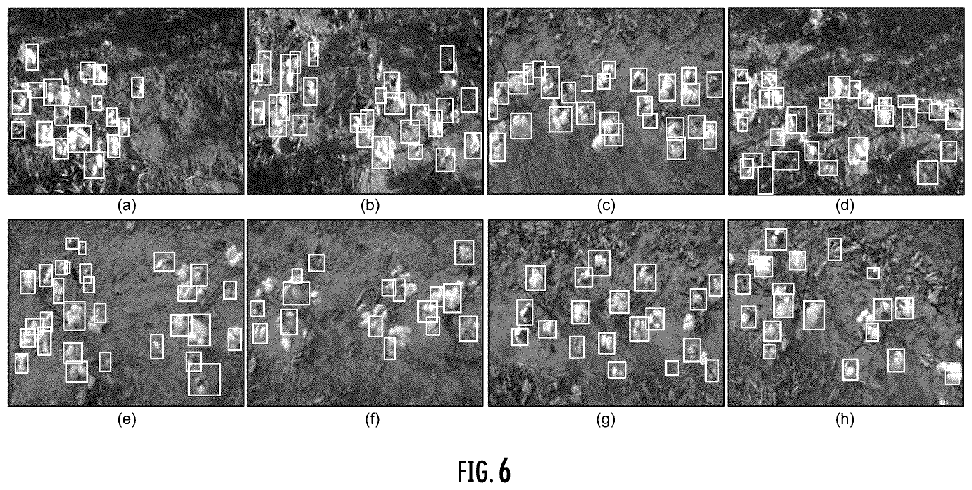

Video acquisition. To construct the dataset we captured multiple video sequences for training and testing. Similar to other tracking datasets, each tracking sequence is 10 to 20 seconds in length. The dataset consists of a total of 30 sequences of which 17 are for training and the remaining 13 are for testing. The video sequences were captured at 4K resolution and at distinct frame rates (e.g., 10, 15, 30). There are typically 2 to 10 cotton bolls per cluster. The average width and height of an annotated bounding box is approximately 230×210 pixels. To make the dataset robust to environmental conditions, we recorded the field videos at separate times of day to account for varying lighting conditions. In total, there are roughly 30×300 frames with 150,000 labeled instances. On average there are 70 unique cotton bolls in each sequence. The directory structure of the dataset is similar to MOT17. The ground truth and the detection files are also available in MOT17 format. Hence, any tracking method that runs on MOT17 can readily utilize the dataset without any additional modifications. Example ground-truth images from the dataset are displayed in FIG. 6. With respect to FIGS. 6a-6h, examples of annotated cotton boll field images with complex backgrounds from an example dataset are shown.

Annotation rules. We followed a set of rules to exhaustively annotate all cotton bolls in each sequence with bounding boxes. The bounding boxes around the cotton bolls are very tight, however there may exist some pixels outside of the bounding box that are part of the boll. A compiled a set of annotation rules is provided in Table 1.

TABLE 1
THE ANNOTATION RULES USED FOR CONSTRUCTING
THE [11] DATASET

| | Rule |
|---|---|
| What | Any open cotton bolls on plants excluding bolls that have |
| | fallen to the ground. |
| When | Start when the enclosing bounding box enters the |
| | frame. Remove as soon as the bounding box goes |
| | beyond the frame border. |
| How | Annotations are not pixel perfect. The majority of |
| | pixels belonging to a cotton boll should be contained |
| | by the bounding box. |
| Occlusion | Annotate a cotton boll as long as it is partially visible |
| | and distinguishable from the neighboring bolls. In |
| | the case of a long occlusion interval, the same ID |
| | is assigned to the occluded boll as long as it is |
| | identifiable. |

Implementation details. To make a fair comparison among existing tracking methods, we generated the same set of detection bounding boxes utilizing a Cascade R-CNN model with a ResNet-50 backbone. Using the (dataset) training data, the model was trained for 100 epochs. The training took place on a CentOS 7.6.1810 machine using an Intel Xeon E5-2620 2.10 GHz CPU, 132 GB of memory, and an NVIDIA Geforce GTX 1080 Ti GPU. The detection accuracy of the trained model was 97% on the test data. We also tried the detector provided by the official Tracktor GitHub repository. However, our detector achieved the best results among all the trackers. For calculating dense optical flow, we made use of the OpenCV implementation of the Gunnar-Farneback algorithm. The estimated flow velocity of a bounding box is computed by averaging the velocities of the center pixels (e.g., a 3×3 window at the bounding box center). The problem of assigning the set of detected bounding boxes to the set of predicted bounding boxes is solved via ByteTrack's association procedure. To estimate the relative location based on the k-nearest neighbors, we empirically opted for a neighbor size of three. If we considered too many neighbors, then the RLA module gave a coarse relative location. Conversely, a single neighbor often provided a noisy estimation. The relative locations along the x (width) and y (height) directions were calculated independently using (7).

Cotton boll tracking evaluation. We evaluated multiple MOT metrics including higher order tracking accuracy (HOTA), identity-aware, and those defined by CLEAR MOT. Association and localization are two major criteria for deciding tracking performance. While measures such as MOTA (accuracy) and MOTP (precision) emphasize localization, the IDP (identification precision), IDR (identification recall), IDF₁ (identification F₁ score), and IDsw (identity switches) put more weight on maintaining true identity. The Frag (fragmentation) metric is the number of times an object is lost, but then redetected in a future frame thus fragmenting the track. The evaluation was performed against the following state-of-the-art tracking methods: DeepSORT, Tracktor, ByteTrack, and Trackformer. As shown in Table II, NTrack outperforms these systems by a significant margin in the majority of the metrics.

TABLE II
A COMPARISON OF NTRACK AGAINST DEEPSORT [6], TRACKTOR
[16], BYTETRACK [19], AND TRACKFORMER [29].
THE ARROW DIRECTIONS INDICATE THE OPTIMAL METRIC VALUES

| Method | IDP↑ | IDR↑ | IDF [symbol] ↑ | HOTA↑ | MOTA↑ | MOTP↑ | IDsw↓ | Frag↓ |
|---|---|---|---|---|---|---|---|---|
| DeepSORT | 82.50% | 81.97% | 82.24% | 66.47% | 84.80% | 80.07% | 1751 | 633 |
| Tracktor | 82.47% | 81.01% | 81.74% | 66.28% | 86.56% | 79.03% | 2070 | 787 |
| ByteTrack | 90.88% | 88.76% | 89.80% | 71.19% | 88.60% | 80.32% | 1193 | 564 |
| TrackFormer | 89.94% | 70.40% | 78.98% | 54.90% | 69.58% | 70.86% | 652 | 311 |
| NTrack (ours) | 93.28% | 91.70% | 92.49% | 73.56% | 89.25% | 81.49% | 1062 | 508 |

[symbol]

indicates data missing or illegible when filed

Our primary goal was to design a tracking system that can count cotton bolls with high accuracy. Thus, by design NTrack should perform better in ID preserving performance metrics. Nevertheless, our tracker outperforms other methods in localization measures as well. In addition, NTrack demonstrates its overall superiority by exceeding others in the HOTA measure, which explicitly balances the effect of performing accurate detection, association, and localization into a single unified metric. To avoid data labeling inconsistencies near the frame border, we considered the ground truth and hypothesis bounding boxes that do not overlap with the frame margin. More specifically, we consider 200 pixels on both sides of a frame as the margin.

Cotton boll counting evaluation. Determining the number of unique cotton bolls in a given video sequence was a prime requirement in designing NTrack. Therefore, when creating the tracker we focused on maintaining the true identity of the bolls. As shown in Table III, the counting results show that NTrack performs exceptionally well at the counting task when compared to other cotton boll counting methods. These results are based on the mean absolute percentage error (MAPE) and root mean square error (RMSE), which are defined as

$$MAPE = \frac{1}{n} {\sum }_{i = 1}^{n} \frac{\vert {C}_{gt} - {C}_{h} \vert}{{C}_{gt}} . \qquad ( 11 )$$

$$RMSE = \sqrt{\frac{1}{n} {\sum }_{i = 1}^{n} {( {C}_{gt} - {C}_{h} )}^{2}} . \qquad ( 12 )$$

In (11) and (12), C_{gt} and Cₕ are the number of unique cotton bolls detected manually (i.e., the ground truth) and by NTrack in the ith video sequence, respectively, and n is the number of video sequences. The results reported for the other methods in Table III are taken from their respective papers since the datasets and source code are not publicly available.

TABLE III
COTTON BOLL COUNTING ERROR

| Method | MAPE↓ | RMSE↓ |
|---|---|---|
| Deep learning [39] | 9.00% | 9.00 (best case) |
| Geometric-feature-based [38] | 15.04% | 7.40 |
| 3D point cloud-based [40] | 10.00% | 16.87 |
| NTrack (ours) | 4.00% | 4.73 |

Table IV shows the performance of NTrack against state of-the-art tracking techniques. The results in Table IV were obtained from experiments done with the same test dataset and protocol. NTrack outperformed all of the other methods. It is interesting to note that TrackFormer, which is based on a transformer architecture, was able to track cotton bolls more consistently than NTrack in terms of ID switching and fragmentation (Table II). Nevertheless, TrackFormer's counting error (8%) is twice that of NTrack (4%).

To demonstrate that the difference in counting performance reported in Table IV is statistically significant, we conducted hypothesis testing. Specifically, we performed one-sided paired t-tests against the other tracking techniques. The null hypothesis of the test is the assumption that the mean counting error of NTrack is greater than or equal to other methods, i.e.,

$${H}_{θ} : {μ}_{n} \geq {μ}_{x} . \qquad ( 13 )$$

Conversely, the alternative hypothesis is the assumption that the mean counting error of NTrack is less than the other methods, i.e.,

$${H}_{a} \text{:} {μ}_{n} < {μ}_{x} . \qquad ( 14 )$$

In (13) and (14), μn and μx are the mean counting errors of NTrack and the other techniques (e.g., DeepSORT, Tracktor, ByteTrack, and TrackFormer), respectively. The test results (p-values) in Table V demonstrate that we can reject the null hypothesis at a significance level of α=0.05 in favor of the alternative hypothesis. In other words, with 95% confidence we can conclude that the test data provides sufficient evidence to support the observation that NTrack's mean counting error is lower than the other methods.

TABLE IV
THE ACCURACY OF NTRACK AGAINST DEEPSORT [6], TRACKTOR [16],
BYTETRACK [19], AND TRACKFORMER [29]. IS SHOWN BY COMPARING
THE GROUND TRUTH (GT) COTTON BOLL COUNTS WITH THE ESTIMATED COUNTS

| | | NTrack (ours) | | DeepSORT | | Tracktor | | ByteTrack | | TrackFormer | |
|---|---|---|---|---|---|---|---|---|---|---|---|
| Sequence | GT | Count | Error % | Count | Error % | Count | Error % | Count | Error % | Count | Error % |
| vid09_01 | 66 | 66 | 0 | 115 | 74 | 220 | 233 | 77 | 17 | 58 | 12 |
| vid09_02 | 72 | 80 | 11 | 146 | 103 | 234 | 225 | 90 | 25 | 74 | 3 |
| vid09_03 | 72 | 67 | 4 | 105 | 46 | 208 | 189 | 78 | 8 | 62 | 14 |
| vid14_0 [symbol] | 95 | 102 | 7 | 2 [symbol] 3 | 14 [symbol] | 396 | 317 | 323 | 29 | 103 | 8 |
| vid23_01 | 60 | 56 | 7 | 136 | 127 | 187 | 212 | 93 | 55 | 57 | 5 |
| vid23_0 [symbol] | 50 | 46 | 8 | 64 | 28 | 136 | 172 | 52 | 4 | 49 | 2 |
| vid23_03 | 96 | 95 | 1 | 140 | 46 | 223 | [symbol] 32 | 101 | 5 | 88 | 8 |
| vid25_01 | 68 | 67 | 1 | 80 | 18 | 1 [symbol] 9 | 15 | 72 | 5 | 64 | 6 |
| vid25_02 | 73 | 72 | 1 | 103 | 4 [symbol] | 119 | 152 | 88 | 21 | 57 | 22 |
| vid25_03 | 61 | 60 | 2 | 69 | 10 | [symbol] | 10 | 62 | 2 | 62 | 2 |
| vid26_01 | 51 | 51 | 0 | 86 | 69 | 134 | 163 | 60 | 18 | 53 | 4 |
| vid26_02 | 66 | 67 | 3 | 79 | 20 | 120 | 82 | 69 | 5 | 59 | 12 |
| vid26_03 | 66 | 69 | 5 | 82 | 24 | 126 | 91 | 73 | 8 | 71 | 8 |
| Mean Error | | | 4 | | 55 | | 163 | | 15 | | 8 |

[symbol]

indicates data missing or illegible when filed

TABLE V
THE HYPOTHESIS TESTING RESULTS ON THE MEAN COTTON
BOLL COUNTING ERROR. FOR EACH COLUMN. WE REPORT
THE TEST RESULT BETWEEN NTRACK AND THE COMPETING
METHOD IN TERMS OF THE P-VALUE

| | ByteTrack | DeepSORT | Tracktor | TrackFormer |
|---|---|---|---|---|
| NTrack | 0.003945 | 0.001769 | 0.000027 | 0.033470 |

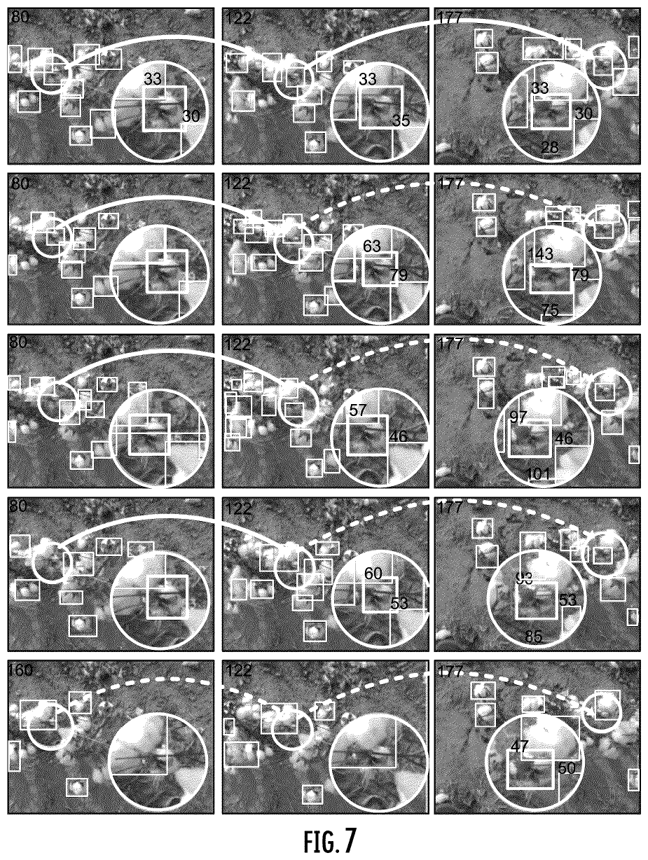

Qualitative evaluation. We conducted a qualitative analysis of NTrack against the trackers in the evaluation set. The first two rows, from the top of FIG. 7, show the tracking outcomes of NTrack and DeepSORT on a test video sequence. In row 2, the arrow highlights the track of a specific cotton boll with an ID of 83. DeepSORT fails to track this boll between frame 122 and frame 177 as indicated by the red arrow. At frame 177, DeepSORT cannot reidentify the previously seen cotton boll (ID 83) and it erroneously assigns a new ID (ID 142). Similarly, Tracktor (row 3, ID 57), and ByteTrack (row 4, ID 60) also fail to track the same cotton boll. TrackFormer (row 5) does not even detect the cotton boll in frames 80 and 122. However, NTrack (row 1) successfully tracks this boll (ID 33) and assigns the same ID in frame 177.

With reference to FIG. 7, an example scenario and qualitative comparison between a multi-object detection and tracking system (NTrack) and conventional methods is illustrated. From top to bottom, each row (NTrack, DeepSORT, Tracktor, ByteTrack, and Trackformer) shows the tracking performance of the different techniques on the same video sequence. The numbers (80, 122, 177) at the top-left corner of each image portray the frame number in the corresponding video sequence. Correct and incorrect associations between cotton bolls are illustrated by the green and red arrows, respectively. The numbers at the top-left corner of each bounding box report the identity of the associated cotton boll assigned by the tracker.

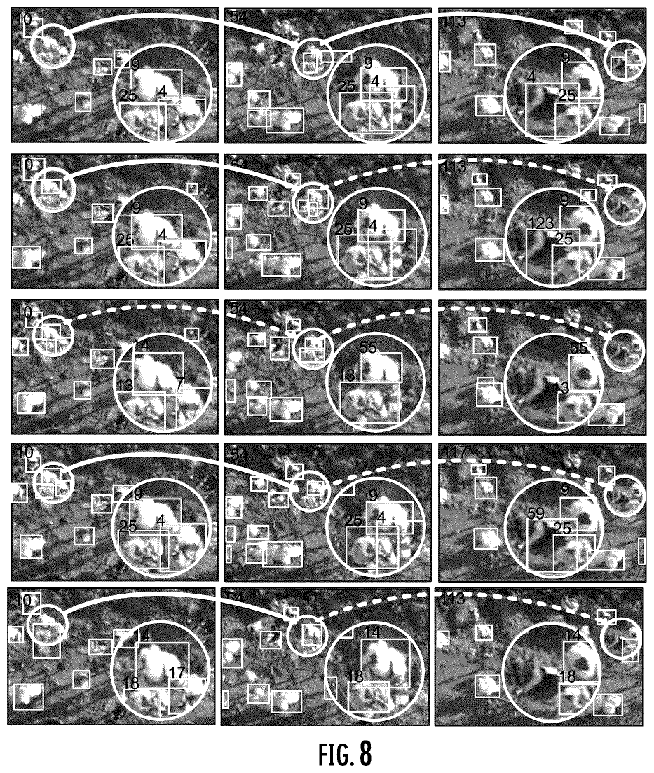

FIG. 8 shows additional qualitative tracking results in a more challenging scenario involving wind. In this scene, a cotton boll (ID 4 in rows 1, 2, 4, ID 7 in row 3, ID 17 in row 5) is occluded for an extended period after frame 54. When the cotton boll reappears in frame 113, it is successfully reidentified by NTrack (row 1). In contrast, DeepSORT and ByteTrack assign a new ID (ID 123 and ID 69 in rows 2 and 4, respectively) to the boll. Tracktor and TrackFormer are unable to detect the cotton boll (rows 3 and 5, respectively). These observations demonstrate the effectiveness of our tracking system in reidentifying cotton bolls, especially in the field under harsh environmental conditions. With respect to FIG. 8, from top to bottom, each row (NTrack, DeepSORT, Tracktor, ByteTrack, and Trackformer) shows the tracking performance of the different techniques on the same video sequence. The numbers (10, 54, 133) at the top-left corner of each image portray the frame number in the corresponding video sequence. Correct and incorrect associations between cotton bolls are illustrated by the green and red arrows, respectively. The numbers at the top-left corner of each bounding box report the identity of the associated cotton boll assigned by the tracker

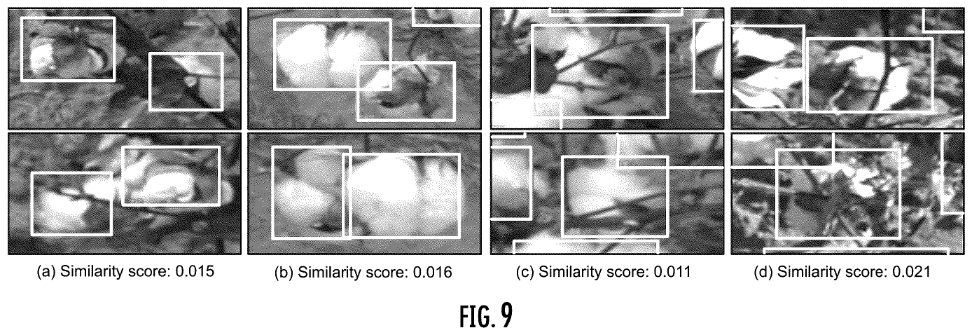

We also qualitatively evaluated NTrack by way of visual appearance-based re-identification of cotton bolls across a video sequence. Examples where appearance-based reidentification fails are shown in FIG. 9. The similarity scores in FIG. 9 are calculated using the cosine similarity between a pair of appearance descriptors (rᵢ, rⱼ). Concretely,

$$cosine similarity ( {r}_{i} , {r}_{j} ) = \frac{{r}_{i}^{⊤} {r}_{j}}{‖ {r}_{i} ‖ \cdot ‖ {r}_{j} ‖} , \qquad ( 15 )$$

where ∥rᵢ∥=∥rⱼ∥=1. (15) outputs a real number in the range [0, 1]. Identical cotton bolls have a cosine similarity score of 1, while distinct bolls have a score of 0.

In the dataset, we hypothesize that all tracking methods that depend on visual appearance to reidentify objects after reappearing will fail to maintain true identity. This is based on the observation that re-identification techniques exploited by many popular tracking methods (e.g., deep cosine metric learning) tend to differentiate objects using color and shape as distinctive features. However, individual cotton bolls have a homogeneous color and shape distribution. Furthermore, the appearance of a cotton boll changes drastically due to the shift in perspective after being occluded for a few frames. Even for an experienced human, it is challenging to reidentify these reappearing cotton bolls. Nevertheless, NTrack can successfully reidentify the bolls (i.e., assign the same ID).

With respect to FIG. 9, NTrack reidentification results are illustrated. Each column shows the same set of cotton bolls. The bottom row shows the bolls after being occluded for several frames. The bounding boxes represent the true identity of the objects and the IDs (e.g., b25, b49, etc.) at the bottom left corner of the bounding boxes are assigned by NTtrack. To highlight the poor performance of visual similarity, each column is accompanied with a cosine similarity score calculated between bounding boxes b25, b49, b44, and b32. The correspondences between the bounding boxes and IDs illustrates that NTrack can successfully reidentify cotton bolls without visual similarity.

Ablation study. To analyze the system design choices, we decoupled and validated the performance impact of each of NTrack's modules. Table VI shows the contributions of the various modules when compared against a ByteTrack baseline. The overall performance of NTrack gradually improved upon integrating each module. The baseline system uses a Kalman filter for motion prediction and an effective association method to reidentify objects. When compared to the baseline, our dynamic motion model improved the IDF1 score by 2%. The combined model, NTrack_motion (baseline+dynamic motion model), also reduced the counting error by a large amount. This supports the hypothesis that for small objects (e.g., fruits, flowers, etc.) that move irregularly in the wild, a dynamic motion model is preferable for tracking.

TABLE VI
A COMPARISON OF THE IMPACT OF INTEGRATING DIFFERENT
MODULES INTO NTRACK AGAINST A BYTETRACK [19] BASELINE.
NTRACK_N1, NTRACK_N3, NTRACK_N5 MODEL USE
1, 3, AND 5 NEIGHBORS RESPECTIVELY, IN THE RLA MODULE

| | Linear | Dynamic | | | | |
|---|---|---|---|---|---|---|
| Method | motion | motion | RLA | IDF₁↑ | MOTA↑ | IDsw↓ |
| Baseline | ✓ | | | 90.3 | 88.9 | 3682 |
| NTrack_motion | | ✓ | | 92.2 | 89.3 | 264 |
| NTrack_N1 | | ✓ | ✓ | 92.5 | 89.5 | 101 |
| NTrack_N3 | | ✓ | ✓ | 92.8 | 89.5 | 85 |
| NTrack_N5 | | ✓ | ✓ | 92.8 | 89.4 | 85 |

We designed the RLA module specifically for identifying occluded cotton bolls. Our experiments show that the RLA module serves its purpose very well. In particular, NTrack achieved the highest scores on the IDF1, MOTA, and IDsw metrics when the RLA module was combined with the dynamic motion model. Although there was only a 0.6% gain in the IDF₁ score due to the addition of the RLA module, the improvement is significant since there are few occluded bolls in a video sequence when compared to the total number of bolls. The number of neighbors (e.g, 1, 3, or 5) in the RLA module was empirically selected for these experiments.

In accordance with the present technology, we described NTrack, a relative location-based MOT system that enables accurate tracking of cotton bolls in outdoor field environments. NTrack is able to robustly maintain object identity and it can reidentify objects after long periods of occlusion, which is a common scenario in agricultural applications. What's more, we introduced the first infield cotton boll video dataset. Using this dataset, NTrack was evaluated against other contemporary MOT techniques and shown to significantly outperform all of them in identity preserving metrics.

### Additional Example Embodiments

Additional non-limiting example embodiments are provided below.

Embodiment 1. A system for multi-object tracking, the system comprising: an optical input device to generate a plurality of frames based on optical information obtained via the optical input device; a detector component in operable communication with the optical input device to identify a plurality of objects in each frame of the plurality of frames; and a tracking component to generate a plurality of trackers, wherein each tracker corresponds to a unique object of the plurality of objects in each frame, and each tracker determines an object trajectory over the plurality of frames.

Embodiment 2. The system of embodiment 1, wherein the detector component determines a bounding box for each object of the plurality of objects in each frame.

Embodiment 3. The system of embodiment 1 or 2, further comprising an optical flow module to determine dense optical flow over the plurality of frames based on a current frame and a previous frame.

Embodiment 4. The system of any of embodiments 1-3, further comprising an association module to determine a set of correspondences between one or more objects identified in each frame and one or more trackers based on a set of matching criteria.

Embodiment 5. The system of any of the preceding embodiments, further comprising a relative location analyzer (RLA) module to estimate a present location of a tracker in a frame based on the tracker's past trajectory and one or more neighboring tracker's past trajectory.

Embodiment 6. The system of any of the preceding embodiments, further comprising a refiner module to suppress a tracker if the tracker's location is determined to be outside a frame and/or the tracker cannot be matched against a detection in a set of recent frames.

Embodiment 7. The system of any of the preceding embodiments, further comprising a predict module to predict the location of a tracker in each frame based on a particle filter.

Embodiment 8. The system of any of the preceding embodiments, wherein the association module generates an association set comprising: one or more active tracks corresponding to matches between identified objects and associated trackers in the plurality of trackers, one or more dormant tracks corresponding to non-matches between identified objects and associated trackers in the plurality of trackers, and one or more unmatched detections corresponding to identified objects and no associated trackers in the plurality of trackers.

Embodiment 9. The system of any of the preceding embodiments, wherein the location states associated with the active tracks and/or the dormant tracks updated for a current frame.

Embodiment 10. The system of any of the preceding embodiments, wherein one or more new tracks are initialized based on the unmatched detections and a detection confidence threshold.

Embodiment 11. A method or computer-implemented method for multi-object tracking, the method comprising: generating a plurality of frames based on optical information obtained via an optical input device, the plurality of frames comprising at least a current frame and a previous frame; determining a set of detections for each frame of the plurality of frames, each detection corresponding to a bounding box associated with a unique object in each frame; and associating each detection with a tracker based at least on the tracker's predicted bounding box in the current frame.

Embodiment 12. The method of embodiment 11, further comprising determining a tracker trajectory for each tracker based on the detected bounding boxes and the associated tracker over the plurality of frames.

Embodiment 13. The method of embodiment 11 or 12, further comprising determining a tracker is active if the tracker can be associated with a detection in a frame.

Embodiment 14. The method of any of embodiments 11-13, further comprising determining a tracker is inactive if the tracker cannot be associated with a detection in a frame.

Embodiment 15. The method of any of embodiments 11-14, further comprising determining a dense optical flow for the current frame with respect to the previous frame.

Embodiment 16. The method of any of embodiments 11-15, further comprising predicting, for each tracker, a current location in the current frame.

Embodiment 17. The method of any of embodiments 11-16, further comprising generating a new tracker if a detection in a frame cannot be associated with a tracker.

Embodiment 18. The method of any of embodiments 11-17, wherein the predicting is based on each trackers past trajectory and one or more neighboring trackers trajectories.

Embodiment 19. The method of any of embodiments 11-18, wherein the state of an active tracker is updated for the current frame.

Embodiment 20. The method of any of embodiments 11-19, wherein the state of an inactive tracker is updated for the current frame.

### REFERENCES

USDA-ERS-1. (2023). Cotton & Wool Overview. [Online]. Available: https://www.ers.usda.gov/topics/crops/cotton-wool/
(2023). National Cottonseed Products Association. [Online]. Available: https://www.cottonseed.com/
M. Reynolds and P. Langridge, “Physiological breeding,” Current Opinion
Plant Biol., vol. 31, pp. 162-171, January 2016.
X. Zhou et al., “Precision farming by cotton producers in fourteen southern states: Results from the 2013 southern cotton farm survey,” Res. Ser., pp. 1-15, 2015.
F. Yu, W. Li, Q. Li, Y. Liu, X. Shi, and J. Yan, “POI: Multiple object tracking with high performance detection and appearance feature,” in Proc. Eur. Conf. Comput. Vis. Cham, Switzerland: Springer, 2016, pp. 36-42.
N. Wojke, A. Bewley, and D. Paulus, “Simple online and realtime tracking with a deep association metric,” in Proc. IEEE Int. Conf. Image Process. (ICIP), September 2017, pp. 3645-3649.
Z. Wang, L. Zheng, Y. Liu, Y. Li, and S. Wang, “Towards realtime multi-object tracking,” in Proc. Eur. Conf. Comput. Vis. Cham, Switzerland: Springer, 2020, pp. 107-122.
D. Koller, J. Weber, and J. Malik, “Robust multiple car tracking with occlusion reasoning,” in Proc. Eur. Conf. Comput. Vis. Cham, Switzerland: Springer, 1994, pp. 189-196.
M. Betke, E. Haritaoglu, and L. S. Davis, “Real-time multiple vehicle detection and tracking from a moving vehicle,” Mach. Vis. Appl., vol. 12, no. 2, pp. 69-83, August 2000.
J. R. Mauney, “Vegetative growth and development of fruiting sites,” Cotton Physiol., vol. 1, pp. 11-28, January 1986.
A. L. Muzaddid, M. D. Ahmed, and W. J. Beksi, Version 1, 2023. [Online]. Available: https://doi.org/10.18738/T8/5M9NCI
W. Luo, J. Xing, A. Milan, X. Zhang, W. Liu, and T.-K. Kim, “Multiple object tracking: A literature review,” Artif. Intell., vol. 293, April 2021, Art. no. 103448.
L. Zhang, Y. Li, and R. Nevatia, “Global data association for multiobject tracking using network flows,” in Proc. IEEE Conf. Comput. Vis. Pattern Recognit., June 2008, pp. 1-8.
C. Huang, B. Wu, and R. Nevatia, “Robust object tracking by hierarchical association of detection responses,” in Proc. Eur. Conf. Comput. Vis. Cham, Switzerland: Springer, 2008, pp. 788-801.
B. Yang, C. Huang, and R. Nevatia, “Learning affinities and dependencies for multi-target tracking using a CRF model,” in Proc. CVPR, June 2011, pp. 1233-1240.
P. Bergmann, T. Meinhardt, and L. Leal-Taixe, “Tracking without bells and whistles,” in Proc. IEEE/CVF Int. Conf. Comput. Vis. (ICCV), October 2019, pp. 941-951.
G. Braso and L. Leal-Taixe, “Learning a neural solver for multiple object tracking,” in Proc. IEEE/CVF Conf. Comput. Vis. Pattern Recognit. (CVPR), June 2020, pp. 6246-6256.
Y. Zhang, C. Wang, X. Wang, W. Zeng, and W. Liu, “FairMOT: On the fairness of detection and re-identification in multiple object tracking,” Int. J. Comput. Vis., vol. 129, no. 11, pp. 3069-387, November 2021.
Y. Zhang et al., “ByteTrack: Multi-object tracking by associating every detection box,” in Proc. Eur. Conf. Comput. Vis. Cham, Switzerland: Springer, 2022, pp. 1-21.
L. Leal-Taixe, M. Fenzi, A. Kuznetsova, B. Rosenhahn, and S. Savarese, “Learning an image-based motion context for multiple people tracking,” in Proc. IEEE Conf. Comput. Vis. Pattern Recognit., June 2014, pp. 3542-3549.
A. Bewley, Z. Ge, L. Ott, F. Ramos, and B. Upcroft, “Simple online and realtime tracking,” in Proc. IEEE Int. Conf. Image Process. (ICIP), September 2016, pp. 3464-3468.
H. W. Kuhn, “The Hungarian method for the assignment problem,” Nav. Res. Logistics, vol. 52, no. 1, pp. 7-21, February 2005.
W. Zheng and S. M. Bhandarkar, “A boosted adaptive particle filter for face detection and tracking,” in Proc. Int. Conf. Image Process., October 2006, pp. 28-39.
Y. Li, H. Ai, T. Yamashita, S. Lao, and M. Kawade, “Tracking in low frame rate video: A cascade particle filter with discriminative observers of different life spans,” IEEE Trans. Pattern Anal. Mach. Intell., vol. 30, no. 10, pp. 1728-1740, October 2008.
W. Choi, “Near-online multi-target tracking with aggregated local flow descriptor,” in Proc. IEEE Int. Conf. Comput. Vis. (ICCV), December 2015, pp. 3029-3037.
J. H. Yoon, M.-H. Yang, J. Lim, and K.-J. Yoon, “Bayesian multi-object tracking using motion context from multiple objects,” in Proc. IEEE Winter Conf. Appl. Comput. Vis., January 2015, pp. 33-40.
A. Mauri et al., “Deep learning for real-time 3D multi-object detection, localisation, and tracking: Application to smart mobility,” Sensors, vol. 20, no. 2, p. 532, January 2020.
C. Godard, O. M. Aodha, M. Firman, and G. Brostow, “Digging into self-supervised monocular depth estimation,” in Proc. IEEE/CVF Int. Conf. Comput. Vis. (ICCV), October 2019, pp. 3827-3837.
T. Meinhardt, A. Kirillov, L. Leal-Taixe, and C. Feichtenhofer, “TrackFormer: Multi-object tracking with transformers,” in Proc. IEEE/CVF Conf. Comput. Vis. Pattern Recognit. (CVPR), June 2022, pp. 8834-8844.
F. Porikli, O. Tuzel, and P. Meer, “Covariance tracking using model update based on lie algebra,” in Proc. IEEE Comput. Soc. Conf. Comput. Vis. Pattern Recognit., June 2006, pp. 728 735.
D. Mitzel and B. Leibe, “Real-time multi-person tracking with detector assisted structure propagation,” in Proc. IEEE Int. Conf. Comput. Vis. Workshops, November 2011, pp. 974-981.
W. Choi and S. Savarese, “A unified framework for multi-target tracking and collective activity recognition,” in Proc. Eur. Conf. Comput. Vis. Cham, Switzerland: Springer, 2012, pp. 215-230.
C. Hung, J. Underwood, J. Nieto, and S. Sukkarieh, “A feature learning based approach for automated fruit yield estimation,” in Field and Service Robotics. Cham, Switzerland: Springer, 2015, pp. 485-498.
S. W. Chen et al., “Counting apples and oranges with deep learning: A data-driven approach,” IEEE Robot. Autom. Lett., vol. 2, no. 2, pp. 781-788, April 2017.
P. Roy and V. Isler, “Surveying apple orchards with a monocular vision system,” in Proc. IEEE Int. Conf. Autom. Sci. Eng. (CASE), August 2016, pp. 916-921.
N. Hani, P. Roy, and V. Isler, “Apple counting using convolutional neural networks,” in Proc. IEEE/RSJ Int. Conf. Intell. Robots Syst. (IROS), October 2018, pp. 2559-2565.
M. Afonso et al., “Tomato fruit detection and counting in greenhouses using deep learning,” Frontiers Plant Sci., vol. 11, p. 1759, November 2020.
R. Kirk, M. Mangan, and G. Cielniak, “Robust counting of soft fruit through occlusions with re-identification,” in Proc. Int. Conf. Comput. Vis. Syst. Cham, Switzerland: Springer, 2021, pp. 211-222.
S. Sun, C. Li, A. H. Paterson, P. W. Chee, and J. S. Robertson, “Image processing algorithms for infield single cotton boll counting and yield prediction,” Comput. Electron. Agricult., vol. 166, November 2019, Art. no. 104976.
D. Tedesco-Oliveira, R. Pereira da Silva, W. Maldonado, and C. Zerbato, “Convolutional neural networks in predicting cotton yield from images of commercial fields,” Comput. Electron. Agricult., vol. 171, April 2020, Art. no. 105307.
S. Sun et al., “Three-dimensional photogrammetric mapping of cotton bolls in situ based on point cloud segmentation and clustering,” ISPRS J. Photogramm. Remote Sens., vol. 160, pp. 195-207, February 2020.
G. Farneback, “Two-frame motion estimation based on polynomial expansion,” in Proc. Scandin. Conf. Image Anal. Cham, Switzerland: Springer, 2003, pp. 363-370.
P. Bromiley, “Products and convolutions of Gaussian probability density functions,” Tina-Vis. Memo, vol. 3, no. 4, p. 1, 2003.
A. Milan, L. Leal-Taixe, I. Reid, S. Roth, and K. Schindler, “MOT16: A benchmark for multi-object tracking,” 2016, arXiv: 1603.00831.
Z. Cai and N. Vasconcelos, “Cascade R-CNN: Delving into high quality object detection,” in Proc. IEEE/CVF Conf. Comput. Vis. Pattern Recognit., June 2018, pp. 6154-6162.
G. Bradski, “The OpenCV library,” Dr. Dobb's J. Softw. Tools Prof. Program., vol. 25, no. 11, pp. 120-123, 2000.
J. Luiten et al., “HOTA: A higher order metric for evaluating multiobject tracking,” Int. J. Comput. Vis., vol. 129, no. 2, pp. 548-578, February 2021.
E. Ristani, F. Solera, R. Zou, R. Cucchiara, and C. Tomasi, “Performance measures and a data set for multi-target, multi-camera tracking,” in Proc. Eur. Conf. Comput. Vis. Cham, Switzerland: Springer, 2016, pp. 17-35.
K. Bernardin and R. Stiefelhagen, “Evaluating multiple object tracking performance: The CLEAR MOT metrics,” EURASIP J. Image Video Process., vol. 2008, pp. 1-10, January 2008.
N. Wojke and A. Bewley, “Deep cosine metric learning for person reidentification,” in Proc. IEEE Winter Conf. Appl. Comput. Vis. (WACV), March 2018, pp. 748-756.

Many different arrangements of the various components and/or steps depicted and described, as well as those not shown, are possible without departing from the scope of the claims below. Embodiments of the present technology have been described with the intent to be illustrative rather than restrictive. Alternative embodiments will become apparent from reference to this disclosure. Alternative means of implementing the aforementioned can be completed without departing from the scope of the claims below. Certain features and subcombinations are of utility and can be employed without reference to other features and subcombinations and are contemplated within the scope of the claims.

1. A system for multi-object tracking, the system comprising:
an optical input device to generate a plurality of frames based on optical information obtained via the optical input device;
a detector component in operable communication with the optical input device to identify a plurality of objects in each frame of the plurality of frames; and
a tracking component to generate a plurality of trackers, wherein each tracker corresponds to a unique object of the plurality of objects in each frame, and each tracker determines an object trajectory over the plurality of frames.

2. The system of claim 1, wherein the detector component determines a bounding box for each object of the plurality of objects in each frame.

3. The system of claim 1, further comprising an optical flow module to determine dense optical flow over the plurality of frames based on a current frame and a previous frame.

4. The system of claim 1, further comprising an association module to determine a set of correspondences between one or more objects identified in each frame and one or more trackers based on a set of matching criteria.

5. The system of claim 1, further comprising a relative location analyzer (RLA) module to estimate a present location of a tracker in a frame based on the tracker's past trajectory and one or more neighboring tracker's past trajectory.

6. The system of claim 4, further comprising a refiner module to suppress a tracker if the tracker's location is determined to be outside a frame and/or the tracker cannot be matched against a detection in a set of recent frames.

7. The system of claim 1, further comprising a predict module to predict the location of a tracker in each frame based on a particle filter.

8. The system of claim 4, wherein the association module generates an association set comprising: one or more active tracks corresponding to matches between identified objects and associated trackers in the plurality of trackers, one or more dormant tracks corresponding to non-matches between identified objects and associated trackers in the plurality of trackers, and one or more unmatched detections corresponding to identified objects and no associated trackers in the plurality of trackers.

9. The system of claim 8, wherein the location states associated with the active tracks and/or the dormant tracks updated for a current frame.

10. The system of claim 1, wherein one or more new tracks are initialized based on the unmatched detections and a detection confidence threshold.

11. A computer-implemented method for multi-object tracking, the method comprising:
generating a plurality of frames based on optical information obtained via an optical input device, the plurality of frames comprising at least a current frame and a previous frame;
determining a set of detections for each frame of the plurality of frames, each detection corresponding to a bounding box associated with a unique object in each frame;
associating each detection with a tracker based at least on the tracker's predicted bounding box in the current frame.

12. The method of claim 11, further comprising determining a tracker trajectory for each tracker based on the detected bounding boxes and the associated tracker over the plurality of frames.

13. The method of claim 11, further comprising determining a tracker is active if the tracker can be associated with a detection in a frame.

14. The method of claim 11, further comprising determining a tracker is inactive if the tracker cannot be associated with a detection in a frame.

15. The method of claim 11, further comprising determining a dense optical flow for the current frame with respect to the previous frame.

16. The method of claim 15, further comprising predicting, for each tracker, a current location in the current frame.

17. The method of claim 11, further comprising generating a new tracker if a detection in a frame cannot be associated with a tracker.

18. The method of claim 16, wherein the predicting is based on each trackers past trajectory and one or more neighboring trackers trajectories.

19. The method of claim 13, wherein the state of an active tracker is updated for the current frame.

20. The method of claim 14, wherein the state of an inactive tracker is updated for the current frame.
